(19) United States
(12) Patent Application Publication
(10) Pub. No.: US 2016/0203256 A1
(43) Pub. Date: Jul. 14, 2016

(54) INTER-CLASS MOLECULAR ASSOCIATION CONNECTIVITY MAPPING

(71) Applicant: Medeolinx, LLC, Indianapolis, IN (US)

(72) Inventor: Jake Yue Chen, Indianapolis, IN (US)

(21) Appl. No.: 15/076,251

(22) Filed: Mar. 21, 2016

Related U.S. Application Data
(63) Continuation of application No. 14/059,181, filed on Oct. 21, 2013.
Application No. 14/059,181 is a continuation of application No. 13/172,423, filed on Jun. 29, 2011, now abandoned.
(60) Provisional application No. 61/359,429, filed on Jun. 29, 2010.

(51) Int. Cl. G06F 19/16; G06F 17/30; G06F 19/00

(52) U.S. Cl. CPC G06F 19/16; G06F 19/3443; G06F 17/3053

(57) ABSTRACT

Methods, systems, devices and/or apparatuses are provided for computationally deriving molecular association connectivity maps for the study of inter-class molecular associations in toxicogenomics and drug discovery applications. The inter-class molecular associations can be between at least one bio-molecular entity and at least one therapeutic agent. The methods, systems, devices and/or apparatuses apply integrated molecular interaction network mining and text mining techniques.

### PRIORITY & CROSS-REFERENCE TO RELATED APPLICATIONS

This application is related to, claims the priority benefit of, and is a U.S. continuation application of, U.S. patent application Ser. No. 14/059,181, filed Oct. 21, 2013 which is related to claims the priority benefit of, and is a U.S. continuation application of, U.S. patent application Ser. No. 13/172,423, filed Jun. 29, 2011, which is related to, and claims the priority benefit of, U.S. Provisional Patent Application No. 61/359,429, filed Jun. 29, 2010. Each of the foregoing patent applications is incorporated herein by reference as if set forth in their entirety.

### FIELD OF THE DISCLOSURE

The present disclosure generally relates to methods, systems, devices and/or apparatuses for deriving molecular connectivity maps. More specifically, the present disclosure relates to methods, systems, devices and/or apparatuses for computationally deriving inter-class molecular association connectivity maps for toxicogenomics and therapeutic agent discovery applications.

### BACKGROUND

Molecular connectivity maps have been gaining popularity in systems biology. Massive amounts of genomics, functional genomics, metabolomics and proteomics information, including genome-wide genetic variations, epigenetic modifications, mRNA expression profiles, protein expression profiles, protein post-translational modifications, and metabolic profile changes in cells, have been generated.

While there may be steady progress in managing and interpreting data for each type of measurement individually, it remains uncertain how to develop unified models to integrate signals from genomic-scale measurements of different molecular entities under similar biological conditions. In modern therapeutic agent discovery, for example, the expression level of bio-molecular entities such as genes or proteins that change in response to different therapeutic agent perturbations, or “bio-molecular entity-therapeutic agent association profiles,” may provide valuable insight on a therapeutic agent's potential molecular therapeutic and toxicological profiles prior to clinical trials. The concept of “inter-class” molecular associations may be quite different from that of “intra-class” molecular associations such as gene-gene interactions, protein-protein interactions, or therapeutic agent-therapeutic agent interactions.

Generalizing from bio-molecular entity-therapeutic agent molecular connectivity profiles built from bio-molecular entities and/or therapeutic entities, the comprehensive inter-class molecular associations in a given biological context may be denoted as a molecular association connectivity map. Molecular association connectivity maps may be developed between therapeutic agents and a wide range of bio-molecular entities such as genes, microRNAs, proteins, and metabolites for a variety of disease areas. Maps between therapeutic agents and such bio-molecular entities may enable researchers to simultaneously compare the molecular therapeutic/toxicological profiles of many candidate therapeutic agents. As explained in detail below, current methods of generating molecular association connectivity maps can be expensive and time-consuming.

It may be beneficial to provide high-quality molecular association connectivity maps to assist researchers in comparing molecular therapeutic/toxicological profiles of many candidate therapeutic agents or a therapeutic agent's target bio-molecular entity/entities. This may improve the chances of developing high-quality therapeutic agents and reducing development time. Additionally, to achieve improved data coverage and quality, a series of statistical and computational methods may be developed to overcome high levels of data noise that may exist in biological networks and literature abstracts.

### BRIEF SUMMARY

Methods, systems, devices and/or apparatuses are provided for computationally deriving molecular association connectivity maps for the study of inter-class molecular associations in toxicogenomics and drug discovery applications. The inter-class molecular associations can be between at least one bio-molecular entity and at least one therapeutic agent. The methods, systems, devices and/or apparatuses apply integrated molecular interaction network mining and text mining techniques.

In one aspect, a method of deriving an inter-class molecular association connectivity map can be summarized as including the steps of network mining, text mining, and connectivity mapping.

In some embodiments, the step of network mining includes generating a list of at least one bio-molecular entity. Alternatively, the step of network mining includes receiving a list of at least one bio-molecular entity from at least one human bio-molecular entity interaction database. Regardless of how one obtains it, the list of at least one bio-molecular entity can include data relating to a plurality of bio-molecular entities. Moreover, the list of at least one bio-molecular entity from the at least one human bio-molecular entity interaction database can be from a curated source or from a source associated with a specific disease. In any embodiment, the at least one bio-molecular entity can be a nucleic acid molecule, amino acid molecule, lipid molecule, saccharide molecule, metabolite or combination thereof. Likewise, in any embodiment, the at least one bio-molecular entity can be a disease-related bio-molecular entity.

In some embodiments, the step of text mining includes generating a list of at least one therapeutic agent. Alternatively, the step of text mining includes receiving a list of at least one therapeutic agent from at least one medical research literature database. In any embodiment, the at least one therapeutic agent can be a small molecule, nucleic acid-based molecule, or amino acid-based molecule. Likewise, in any embodiment, the at least one therapeutic agent can be a disease-related therapeutic agent.

In some embodiments, the step of connectivity mapping includes relating the results of the network mining and text mining. The results of the network mining and text mining can be related by generating a connectivity score for each possible bio-molecular entity-therapeutic agent combination. The connectivity scores, at least in part, can be used for deriving an inter-class molecular association connectivity map as a two-dimensional (“2-D”) matrix having a plurality of colored and/or shaded cells associated with the connectivity scores. The connectivity scores can be indicative of the extent of medical literature involving the at least one bio-molecular entity and the at least one therapeutic agent.

In some embodiments, the method further includes the step of filtering the inter-class molecular association connectivity map to output only disease-related bio-molecular entity-therapeutic agent combinations associated with at least one specific disease.

In some embodiments, the inter-class molecular association can be a nucleic acid molecule-therapeutic agent association, amino acid molecule-therapeutic agent association, or nucleic acid/amino acid-therapeutic agent association.

In another aspect, a system for deriving an inter-class molecular association connectivity map can be summarized as including a network construction component, text retrieval and information extraction component, and molecular connectivity mapping component.

In some embodiments, the network construction component can be at least one bio-molecular entity database, where each bio-molecular entity database is configured to store bio-molecular entity data related to one of a plurality of bio-molecular entities. As above, the bio-molecular entity can be a disease-related bio-molecular entity.

In some embodiments, the text retrieval and information extraction component can be at least one therapeutic agent database, where each therapeutic agent database is configured to store therapeutic data related to one of a plurality of therapeutic agents. As above, the therapeutic agent can be a disease-related therapeutic agent.

In some embodiments, the connectivity mapping component can be configured to analyze bio-molecular entity data and therapeutic agent data and output a bio-molecular entity-therapeutic agent molecular association connectivity map representing associations and/or non-associations between the plurality of bio-molecular entities and the plurality of therapeutic agents. Moreover, the molecular association connectivity mapping component can be configured to output, cluster, and/or filter the bio-molecular entity-therapeutic agent molecular association connectivity map with respect to at least one specific disease.

In some embodiments, the inter-class molecular association connectivity map includes a two-dimensional table relating associations and/or non-associations between the plurality of bio-molecular entities and the plurality of therapeutic agents. A connectivity score can represent the associations and/or non-associations between the plurality of bio-molecular entities and the plurality of therapeutic agents, where the two-dimensional table can include a plurality of colored and/or shaded cells associated with the connectivity score. Moreover, the connectivity score can include a statistical confidence score that indicates an extent of literature studies involving one of the plurality of bio-molecular entities and one of the plurality of therapeutic agents.

In some embodiments, the bio-molecular entity data and/or therapeutic agent data can be obtained by data mining medical research documents.

In yet another aspect, a device and/or apparatus for deriving an inter-class molecular association connectivity map can be summarized as a web server configured to perform the methods described herein. Alternatively, the device and/or apparatus for deriving the inter-class molecular association connectivity map can be summarized as computer-readable medium having instructions to perform the methods described herein. Alternatively still, the device and/or apparatus for deriving the inter-class molecular association connectivity map can be summarized as a memory device having software configured to perform the methods described herein.

Advantageously, the inventions described herein can be performed computationally (i.e., in silico) and therefore do not require studies such as gene expression profiling (e.g., therapeutic agent perturbation experiments) on control and disease samples.

### BRIEF DESCRIPTION OF THE DRAWINGS

FIG. 1 is a diagram depicting an exemplary embodiment of the present invention.

FIG. 2 is an example connectivity map generated in an example embodiment of the present invention.

FIG. 3 is a flow diagram depicting another exemplary embodiment of the present invention.

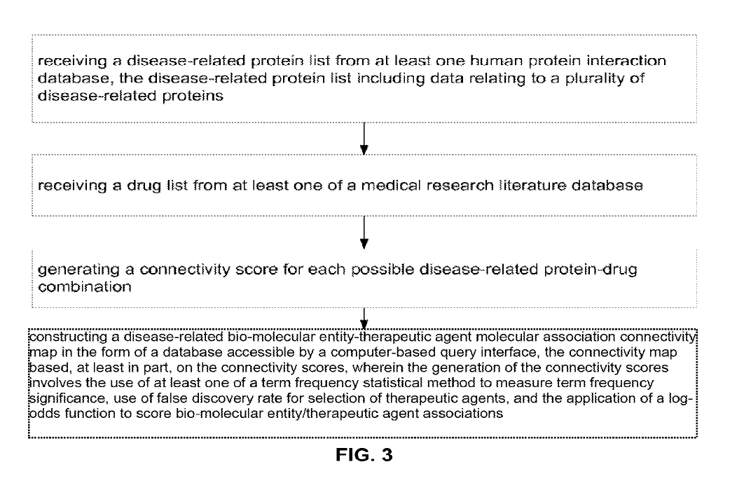

FIG. 4 is a flow diagram depicting yet another exemplary embodiment of the present invention.

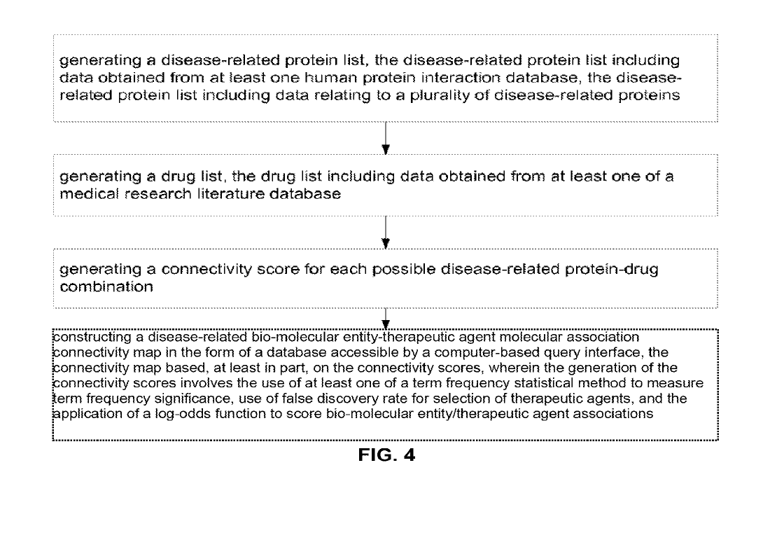

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and appended claims are not meant to be limiting. Other embodiments may be utilized, and other changes may be made, without departing from the spirit or scope of the subject matter presented here. It will be readily understood that aspects of the present disclosure, as generally described herein, and illustrated in the drawings, may be arranged, substituted, combined, and designed in a wide variety of different configurations, all of which are explicitly contemplated and make part of this disclosure.

Unless defined otherwise, all technical and scientific terms used herein have the same meaning as commonly understood by one of skill in the art to which the invention pertains. Although any methods and materials similar to or equivalent to those described herein can be used in the practice or testing of the present invention, the preferred methods and materials are described herein.

One challenge that arises throughout medicine is a need to establish a functional connection among diseases, physiological processes, and the action of therapeutic agents used to treat such diseases. As used herein, “therapeutic agent” or “therapeutic agents” means a small molecule, nucleic acid-based molecule, amino acid-based molecule, or cell-based composition having a desired biological or pharmacological effect when administered to an individual having or suspected of having a particular condition or disease.

As used herein, “small molecule” or “small molecules” means an organic compound or compounds, whether naturally occurring or artificially created (e.g., via chemical synthesis) that have a relatively low molecular weight and that are not nucleic acids, peptides, oligopeptides, polypeptides, or proteins. Small molecules typically have a molecular weight of less than about 800 Daltons and can have multiple carbon-carbon bonds. Examples of small molecule therapeutic agents include, but are not limited to, antibiotics, antivirals, antifungals, chemotherapeutics, and radiotherapeutics.

As used herein, “nucleic acid-based molecule” or “nucleic acid-based molecules” means a deoxyribonucleotide (“DNA”) or ribonucleotide (“RNA”) polymer (i.e., polynucleotide) in either single- or double-stranded form that, unless otherwise limited, encompasses naturally occurring bases (i.e., adenine, guanine, cytosine, thymine and uracil) or known base analogues having the essential nature of natural nucleotides in that they hybridize to single-stranded nucleic acid molecules in a manner similar to naturally occurring nucleotides. The term encompasses sequences that include any of the known base analogues of DNA and RNA such as, but not limited to 4-acetylcytosine, 8-hydroxy-N6-methyladenosine, aziridinylcytosine, pseudoisocytosine, 5-(carboxyhydroxylmethyl) uracil, 5-fluorouracil, 5-bromouracil, 5-carboxymethylaminomethyl-2-thiouracil, 5-carboxymethylaminomethyluracil, dihydrouracil, inosine, N6-isopentenyladenine, 1-methyladenine, 1-methylpseudouracil, 1-methylguanine, 1-methylinosine, 2,2-dimethylguanine, 2-methyladenine, 2-methylguanine, 3-methylcytosine, 5-methylcytosine, N6-methyladenine, 7-methylguanine, 5-methylaminomethyluracil, 5-methoxyaminomethyl-2-thiouracil, beta-D-mannosylqueosine, 5′-methoxycarbonylmethyluracil, 5-methoxyuracil, 2-methylthio-N6-isopentenyladenine, uracil-5-oxyacetic acid methylester, uracil-5-oxyacetic acid, oxybutoxosine, pseudouracil, queosine, 2-thiocytosine, 5-methyl-2-thiouracil, 2-thiouracil, 4-thiouracil, 5-methyluracil, -uracil-5-oxyacetic acid methylester, uracil-5-oxyacetic acid, pseudouracil, queosine, 2-thiocytosine, and 2,6-diaminopurine. Examples of nucleic acid-based molecule therapeutic agents include, but are not limited to, antigene nucleic acid sequences, anti-sense nucleic acid sequences, aptamers, ribozymes, RNAi, and siRNA.

As used herein, “amino acid-based molecule” or “amino acid-based molecules” means mean a polymer of amino acid residues, where each residue contains an amine group, a carboxylic acid group and a side-chain that varies between different amino acids. The terms apply to amino acid polymers in which one or more amino acid residues is an artificial chemical analogue of a corresponding naturally occurring amino acid, as well as to naturally occurring amino acid polymers. Examples of amino acid-based molecule therapeutic agents include, but are not limited to, antibodies, blood proteins and clotting/coagulation factors, enzymes, hormones, and vaccines.

As used herein “cell-based composition” or “cell-based compositions” means a composition comprising cells. Examples of cell-based compositions include, but are not limited to, a somatic cell composition, adult stem cell compositions, embryonic stem cell compositions, fetal stem cell compositions, and induced pluripotent stem cells compositions. The cell-based composition can be homogenous or heterogeneous. When the cell-based composition includes somatic cells, the somatic cells can be selected from a pancreatic islet cell, central nervous system (“CNS”) cell, peripheral nervous system (“PNS”) cell, cardiac cell, skeletal muscle cell, smooth muscle cell, hematopoietic cell, bone cell, liver cell, adipose cell, renal cell, lung cell, chondrocyte, skin cell, follicular cell, vascular cell, epithelial cell, immune cell, retinal cell, corneal cell, or endothelial cell.

The present disclosure contemplates that some large-scale projects currently are being developed or are underway to establish molecular association connectivity maps. As used herein, “molecular association connectivity map” means a 2-D map displaying connections between, for example, bio-molecular entities and therapeutic agents, which can be used to find functional connections among therapeutic agents sharing a mechanism of action, chemicals and physiological processes, and diseases and therapeutic agents.

As used herein, “bio-molecular entity” or “bio-molecular entities” means a molecule or molecules produced by an organism including, but not limited to, nucleic acid molecules such as DNA (i.e., genes), mRNA, and microRNA; amino acid molecules such as peptides, oligopeptides, polypeptides, and proteins; carbohydrate molecules such as polysaccharide; lipid molecules such as fatty acids and sterols; as well as metabolites and/or combinations of any of the foregoing. The bio-molecular entity therefore can be a monomer, oligomer, or polymer.

One example includes a systematic approach to build connectivity maps using gene-expression profiling as the common vocabulary that connects small molecules, genes, and diseases. See, Lamb (2007) Nat. Rev. Cancer 7:54-60. These connectivity maps may consist of a reference collection of gene-expression profiles from cultured human cells treated with bioactive small molecules. The map data also may come with pattern-matching software to help researchers query these maps.

Another example includes using the Unified Medical Language System (“UMLS”) ontology and publicly available gene expression data to associate a broad spectrum of “vantage points” (biologically significant terms used in phenotypic, disease, environmental and experimental contexts) with genes. See, Butte & Kohane (2006) Nat. Biotechnol. 24:55-62.

While both examples may open up new opportunities to observe molecular connectivity profiles in parallel, the coverage and quality of these examples raise doubts. The first example relies on systematic screening of each known chemical compound against cell lines simulating each biological condition to derive gene expression profile changes. This is a costly and time-consuming experimental process that will take many years and a huge budget before sufficient data coverage can be achieved for practical use. The second example relies heavily on integrating available gene expression data from different laboratories running different experimental platforms on different biological samples. This typically produces incompatible results that may require thorough in-depth experimental validations or knowledge curation.

As described herein, it is possible to build a high-quality, low-cost molecular association connectivity map. In building such a molecular association connectivity map, one may resort to the vast amount of biomedical literature and emerging biomedical literature mining techniques. Recent advances in biomedical information retrieval, bio-molecular entity identification, information extraction, text clustering and classification, and the integration of structured and textual data, have made it practical to perform knowledge discovery in primary biomedical literature. There are quite a few successful examples.

One example is Finding Associated Concepts with Text Analysis (“FACTA”; available online by the National Centre for Text Mining at text0.mib.man.ac.uk/software/facta/main.html), which is a biomedical literature search engine for identifying biomedical concepts (e.g., disease, gene/protein, chemical compounds) from PubMed® abstracts. See, Tsuruoka et al. (2008) Bioinformatics 24:2559-2560.

Another example is Genes2Diseases (“G2D”; available online by The European Molecular Biology Laboratory at coot.embl.de/g2d/), which is a tool for inferring logical chains of connections from disease names and ranked genes on the basis of a score that represents their likelihood of being associated with the query disease. See, Perez-Iratxeta et al. (2002) Nat. Genet.31:316-319; and Perez-Iratxeta et al. (2005) BMC Genetics 6:45.

Another example identified co-occurring disease names and tissue names in PubMed® abstracts, and linked the tissues to candidate disease genes. See, Tiffan et al. (2005) Nucleic Acids Res. 33:1544-1522. Yet another example developed a method to explore implicit relationships between pharmacology substances and diseases. See, Srinivasan (2004) J. Am. Soc. Inf. Sci. Tec. 55:396-413. Given disease names and user-specified terms, these biomedical literature-mining techniques may be capable of prioritizing terms (e.g., genes, tissues, and substances etc.) with potential roles in the diseases.

Theoretically, inter-class molecular association connectivity maps may be built by searching, collecting, and “triangulating” (1) disease-related bio-molecular entity, (2) disease-related therapeutic agent, and (3) bio-molecular entity-therapeutic agent term co-occurrences, using existing literature mining methods. A challenge, however, is how to achieve satisfactory sensitivity and specificity from diseases to therapeutic agent, while enabling the discovery of novel applications for known therapeutic agents. An approach that reports only significant associations among bio-molecular entity, therapeutic agent, and disease terms co-cited in the same article may be undesirable, because there would be no new knowledge connections between molecules and diseases. An approach that either misses many therapeutic agents (low sensitivity performance) or assigns unrelated therapeutic agents (low positive predictive value performance) also may be depreciated, because human experts may have to bear a heavy burden of performing manual knowledge validations.

The present disclosure proposes methods, systems and/or devices/apparatuses to develop high-coverage, disease-specific bio-molecular entity-therapeutic agent molecular association connectivity maps. This may be accomplished, for example, by applying integrated molecular interaction network mining and text mining techniques. The present disclosure uncovers interesting and non-obvious patterns by relating research publications on bio-molecular entities, therapeutic agents, and disease contexts.

The methods, systems and/or devices/apparatuses may have the following characteristics:
Incorporating a user input of seed, disease-specific bio-molecular entity or entities derived from prior knowledge. Each seed list may be curated by in-house knowledge experts, extracted computationally from large Omics experimental results (e.g., differentially expressed genes from microarray experiments comparing genes between disease samples and normal samples), or retrieved automatically from online curated databases for the given disease. While the quality of seeds may affect the quality of downstream analysis, these seeds may serve as a starting point and need not be complete or optimized.
Automatically improving the quality of initial seed bio-molecular entities list by expanding and re-ranking them in the functional context by reprioritizing them in disease-related molecular interaction networks. Therefore, the final list of bio-molecular entities used to build connectivity maps may have heightened relevance to the specific disease context.
Discovering therapeutic agents implicitly studied across multiple research papers spanning multiple disciplines. This identification of both explicit and implicit bio-molecular entity-therapeutic agent associations to a disease context may be accomplished by the development of sensitive agent term statistics that do not require the disease terms to co-occur in the same abstract.
Summarizing the comprehensive knowledge of molecular association connectivity data for a given disease context into a 2-D matrix. The 2-D matrix may serve as a knowledge map for all bio-molecular entities and candidate therapeutic agents documented in the literature, with each cell in the matrix containing a statistical confidence score that may be indicative of the extent of literature studies involving a specific bio-molecular entity and a therapeutic agent.

Not only can the retrieval of a disease-related therapeutic agent from biomedical literature be performed with high sensitivity and specificity, but also the opportunity to discover novel therapeutic uses of known therapeutic agents may be realized. A therapeutic agent may be re-discovered in a new disease context, if the statistical inference engine establishes significant links between the therapeutic agent and the majority of disease-related bio-molecular entities in PubMed® abstracts. The molecular association profiles for each therapeutic agent in a particular disease application area may be compared and classified, therefore providing evidence for validating new hypotheses. The potential application of this approach to the identification of new disease therapeutic areas for known therapeutic agents (commonly referred to as drug repurposing or repositioning) may make developing molecular connectivity maps particularly interesting.

Although it is contemplated that any disease can be used, Alzheimer's Disease (“AD”) is used as a case study throughout this disclosure. See, Li et al. (2009) PLOS Comput. Biol. 5:e1000450. It should be noted that the AD case study discussed herein is not meant to be limiting, as the methods, systems, devices and/or apparatuses may be applied to any disease or condition. As used herein, “Alzheimer's Disease” or “AD” means an irreversible, progressive neurodegenerative disease that slowly destroys memory and thinking skills, and eventually even the ability to carry out the simplest tasks. AD has three characteristic hallmarks: (1) amyloid plaques, (2) neurofibrillary tangles, and (3) a loss of connections between neurons in the brain. It is estimated that AD affects nearly 4.5 million Americans of mostly over 60 years old and has become an increasingly prevalent disease among senior citizens.

### Methods and Systems

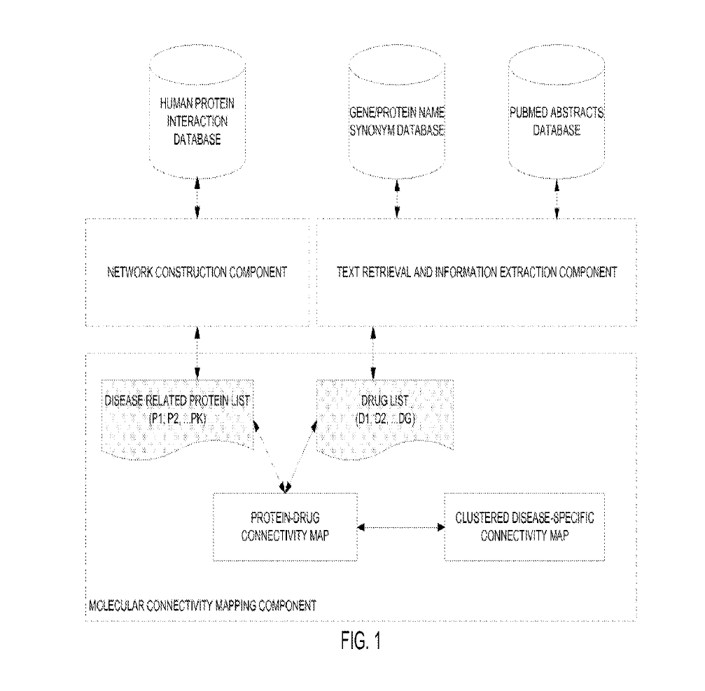

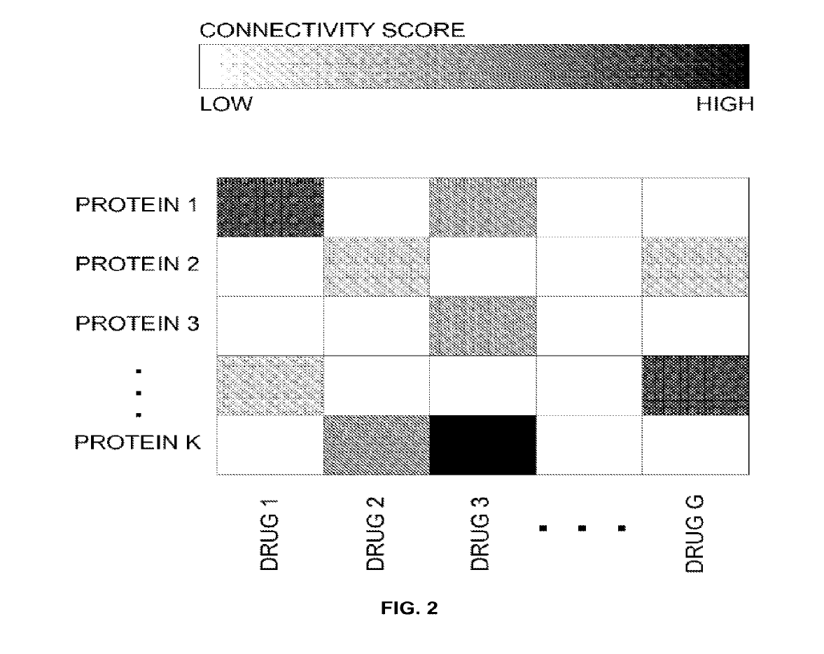

FIG. 1 depicts an example system for deriving disease-specific molecular association connectivity maps. The framework includes at least three components: (1) a network construction component, (2) a text retrieval and information extraction component, and (3) a molecular association connectivity mapping component. FIG. 2 represents an example molecular association connectivity map generated by an example embodiment.

### Identifying and Refining AD-Related Bio-Molecular Entities

In some instances, a prerequisite to generating a molecular association connectivity map may be to generate (or receive) a list of disease-related bio-molecular entities and a list of disease-related therapeutic agents as two attribute dimensions of the 2-D matrix. The quality of the final connectivity map may be affected by the overall relevance of the bio-molecular entities and therapeutic agents to a particular disease.

The bio-molecular entity list can be generated from a variety of sources. In some instances, one may take the list directly from expert-curated data sources. However, for complex diseases, many disease-related bio-molecular entities, especially those associated with elevated disease risks, may not yet all be identified. Moreover, the expression levels of many bio-molecular entities such as genes and proteins are still being investigated experimentally for potential values as disease biomarkers. Researchers may be able to obtain an incomplete “initial seed list” of disease-related seed bio-molecular entities from heterogeneous sources. In other instances, one may rely entirely on known databases such as Online Mendelian Inheritance in Man® (“OMIM”; available online by the National Center for Biotechnology Information at ncbi.nlm.nih.gov/omim) for generating an initial disease-related bio-molecular entity list.

In building the AD molecular association connectivity map, the present disclosure assumes that a user's prior incomplete knowledge on AD is derived entirely from OMIM® (this assumption may be relaxed if one adds supplemental bio-molecular entities (e.g., genes/proteins) to the seed list) and retrieved 49 AD seed proteins (corresponding to 49 genes) from OMIM®.

The present disclosure expands the AD seed proteins using quality-ranked protein interaction data in the Online Predicted Human Interaction Database (“OPHID”; available online by The Ontario Cancer Center/University of Toronto at ophid.utoronto.ca/ophidv2.201/) and a nearest-neighbor protein interaction expansion method, as described below. See, Brown & Jurisica (2005) Bioinformatics 21:2076-2082.

In the expanded AD protein interaction network, there may be 560 proteins and 771 protein interactions, with confidence scores ranging from 0.30 to 1. All 560 proteins may be ranked based on a scoring model as described below. The scoring model may assign each of the 560 proteins an AD protein relevance score based on a protein ranking score rₚ.

The top thirty ranked AD proteins may be sorted in descending order of the protein ranking scores derived from an AD-related protein interaction network. Among the top thirty ranked proteins, twenty-six may be found in the initial OMIM® AD seed protein list, with the exception of four proteins: APBB1_HUMAN, TAU_HUMAN, CTNB1_HUMAN, and DAB1_HUMAN. Two of these four proteins, APBB1_HUMAN and TAU_HUMAN, may be present in the initial seed gene list but absent from the seed protein list after automatic gene-to-protein name conversions. This confirms that molecular network based gene ranking methods (such as CHI, ProteinRank, and/or CGI) could help recover certain biases in the initial seed list.

CTNB1_UMAN is a known AD protein that specifically regulates PSEN1, in which gene mutations can cause elevated accumulation of beta-Amyloid (A4_HUMAN) and lead to early-onset familial AD. DAB1_HUMAN can be associated with the A4_HUMAN protein's cytoplasmic domain, causing it to over-express in hippocampal neurons-a strong indication of its key roles in AD.

It also can be determined that the disease interaction sub-network-based protein ranking result may not be strongly correlated with the usage of these gene terms in literature. In this example, the overlap between two top 500 protein lists selected from the constructed AD network and conventional disease-specific text mining results respectively was only 80 proteins. While A4_HUMAN, PSN1^{—}HUMAN and PSN2_HUMAN were all well cited in literature and highly ranked in AD-related protein interaction network, PIN1_HUMAN, on the other hand, ranked fourth in the AD protein interaction sub-network yet 1,638th in the AD literature. This inconsistency suggests that there may be special opportunities in catapulting current studies of certain proteins into future prominent status that the proteins deserve. Further literature study may confirm that the WW domain of PIN1_HUMAN binds to phosphorylated protein TAU_HUMAN, which is hyper-phosphorylated in AD. Much more detailed semantic analysis of the PubMed® abstracts may be required to derive a comparable high-quality AD protein list without mining disease-relevant proteins in molecular interaction networks context. The high degree of disease relevance of final ranked proteins may lay a solid foundation for building a high-quality connectivity map.

### Statistically Enriching AD-Related Therapeutic Agent Terms

To build the second dimension for an AD molecular connectivity map, one may first retrieve PubMed® abstracts of AD relevance, using the list of AD-related bio-molecular entities (e.g., genes/proteins) derived earlier as queries, and parse out therapeutic agent terms in the retrieved articles.

In the AD example, one may withhold the urge of expediently retrieve PubMed® abstracts using a conventional query term such as “Alzheimer.” Instead, one may generate a PubMed® query including 560 AD-relevant proteins and their synonyms. Such a query may retrieve 222,609 related abstracts, without the explicit context of “Alzheimer.” One reason for this strategy may be to improve recall of AD relevant articles. One can imagine that not all of the research studies involving 560 proteins in PubMed® may be performed in the AD disease context (or in any disease context). For example, a biochemical study of a therapeutic agent's effect on gene expressions may not involve any mention of AD (particularly not so in PubMed® abstracts). Retrieving abstracts in any contexts based on these AD-related proteins to build an initial corpus may be one method of improving recall of information retrieval.

While one could build a database of all current experimental therapeutic agents and approved therapeutic agents for AD, such a database would be of marginal interest to researchers focusing on novel therapeutic agent discovery. Therefore, one may concentrate on first identifying therapeutic agent terms that may be significantly “enriched” in the AD-related literature collection, as compared with the overall PubMed®. Of all current PubMed® abstracts, there are 6,543 “drug chemicals” organized in a hierarchical structure, according to provided MeSH term annotations. Of the 222,609 current AD related PubMed® abstracts retrieved from 560 AD-related proteins, 2,019 therapeutic agents remained, 1,279 of which were determined to be “enriched.” As used herein, “enriched” means an outcome of passing a statistical term enrichment test below a pre-set filter of false discovery rate (“FDR”) less than 0.05, as described below. Again, the associations of these significant therapeutic agent terms to the “Alzheimer” disease context may be made without the explicit term co-occurrence requirement for “Alzheimer” as a query term, or for particular AD genes or proteins in the same abstract. These 1,279 therapeutic agents, therefore, may constitute new knowledge worth investigation and incorporation into the AD connectivity map.

### Assessing Novel AD Therapeutic Agent Identified

To estimate how the network construction component may affect the text retrieval and information extraction component, one may evaluate the performance of AD-related therapeutic agent identification by changing the input of AD seed bio-molecular entities. Given different sets of the initial seed bio-molecular entities, one may calculate sensitivity and specificity at top N drugs determined by FDR. In one example, one may sub-sample 49 AD seed bio-molecular entities into 8 data sets of varying sizes (i.e., S5, S10, S15, S20, S25, S30, S35, S40 (the number indicating size)) and generate a random seed set with 50 bio-molecular entities. The overall specificity and sensitivity may be maintained while the seed set changed from S5 to S40 (overall specificity variance<0.000021 and sensitivity variance<0.00098). The random seed performance may be distinctly lower than any seeding strategies experimented. This shows that potential bias in selecting seed bio-molecular entities may not significantly affect therapeutic agent identifications.

### Creating and Assessing AD Molecular Association Connectivity Map

With a number of bio-molecular entities and therapeutic agents enriched on disease relevance from molecular interaction networks and biomedical literature, a connectivity map with balanced quality and coverage may be generated. The AD connectivity map matrix may include bio-molecular entities as rows, therapeutic agents as columns, and may include a bio-molecular entity-therapeutic agent connectivity score based on co-citation adjusted log-odds values, as described below.

Two dimensional hierarchical clustering may be applied to identify groups of bio-molecular entities that share similar profiles. In the AD connectivity map, bio-molecular entities such as proteins may be clustered between similar therapeutic agent profiles, and therapeutic agents may be clustered between similar bio-molecular entity profiles.

To assess the biological significance of bio-molecular entity-therapeutic agent connectivity scores, one may compare high-scoring bio-molecular entity-therapeutic agent pairs in the AD connectivity map with all known AD therapeutic agent-target relations in DrugBank (a database that combines detailed therapeutic agent (i.e., chemical, pharmacological and pharmaceutical; available online by University of Alberta at drugbank.ca/) data with comprehensive therapeutic agent target (i.e., sequence, structure, and pathway information). Since only six out of eight AD therapeutic agents reported in DrugBank were involved in this example, one may collect the six therapeutic agents' targets from the DrugBank database for comparison. One may use the concept of “target distance” to measure between a bio-molecular entity-therapeutic agent connectivity profile created and the actual therapeutic agent-target knowledge. More precisely, one may define target distance as the shortest distance in the disease-specific bio-molecular entity interaction sub-network between a therapeutic agent's target in DrugBank and the agent's connected bio-molecular entity in the molecular connectivity map. A target distance of zero may refer to a bio-molecular entity in the molecular connectivity map also to be the therapeutic agent's target.

Here, Tacrine and Galantamine targeted their connected protein (ACES_HUMAN) directly, which covered four proteins listed (ACES_HUMAN, CATB_HUMAN, A4_HUMAN, and EP300_HUMAN). Vitamin E seemed to contain several long-range connections to AD proteins, with a target distance of 2. Memantine seemed to be the only example with the farthest known path of protein interactions to its target (target distance=3). All the four highly associated known AD therapeutic agents are within a target distance of 3.

### Exploring AD Molecular Association Connectivity Map

In the AD molecular association connectivity map, the connections between 166 therapeutic agents and 66 bio-molecular entities (e.g., protein/gene) may be reviewed globally or for each pair of therapeutic agent and bio-molecular entity. The AD connectivity map may contain a wealth of information worth investigating by biomedical researchers.

In the AD connectivity map, bio-molecular entities that interact with each other seemed to cluster well with each other based on added entity-therapeutic agent profile similarities. For example, PSN1_HUMAN, FLNA_HUMAN and CSEN_HUMAN share highly similar entity-therapeutic agent connectivity profiles among themselves. According to HPRD, PSN1_HUMAN directly interacts with both CSEN_HUMAN and FLNA_HUMAN. This may be a factor in explaining why therapeutic agents intervening PSN1_HUMAN may affect CSEN_HUMAN and FLNA_HUMAN as well. Also, therapeutic agents such as Diazepam, Clonazepam, Flunitrazepam, Apomorphine, Diltiazem, Prazosin, and Quinidine were clustered closely. When their chemical structures are examined, one may find them to share common two-ring structures. Diazepam, Clonazepam and Flunitrazepam may be further found to contain benzodiazepine as a common structure. Another interesting observation on this group of therapeutic agents may be their shared similar pharmacological actions: Diazepam, Clonazepam and Flunitrazepam for the symptomatic treatment of anxiety disorders, while Diltiazem and Prazosin for the treatment of vascular hypertension. These findings may suggest that a decent degree of accuracy may have been achieved to enable one to drill down to underlying mechanisms, biologically or chemically, between connected molecules.

Investigating Repurposed Candidate Therapeutic Agents from the AD Molecular Association Connectivity Map

Disease-specific molecular connectivity maps may provide novel insights for re-purposing experimental therapeutic agents, successful or failed, from the original intended therapeutic area to a new disease application context. As discussed above, Diltiazem, Prazosin and Quinidine may be clustered together due to their similar connectivity profiles. The three therapeutic agents are previously known to treat vascular diseases. Among them, Diltiazem is an antihypertensive agent with vasodilating actions due to its antagonism of the actions of the calcium ion in membrane function; Prazosin is an alpha-adrenergic blocking agent used in the treatment of heart failure and hypertension; Quinidine is an anti-arrhythmia agent with actions on sodium channels on the neuronal cell membrane.

Recent population-based epidemiological studies suggest that vascular risk factors, such as vascular disease gene ApoE, hypertension, atherosclerosis, and heart failure, may impair cognitive functions and are related to the development of AD. Both randomized and non-randomized clinical trials indicate that lowing blood pressure may play an important role in preventing AD. Further trials also demonstrated that antihypertensive agents may decrease the incidence of dementia in stroke patients and, in elderly patients with isolated systolic hypertension. Additionally, Valsartan, an anti-hypertensive chemical, may reduce AD-like symptoms in mice. When one looks into clinical trial databases, they may find that Prazosin is currently under a double-blind and placebo-controlled clinical study on the treatment of agitation and aggression in persons with AD, while Diltiazem and Quinidine have not been experimented for any AD related treatment. With this in mind, Diltiazem and Quinidine may become worthwhile candidates for future AD drug re-purposing investigation because of the molecular connectivity maps discussed herein. Drug developers may now hypothesize on therapeutic values of these two candidate drugs (as related to AD).

Several factors may contribute to the effectiveness of the molecular connectivity mapping framework. First, all biomedical abstracts in PubMed® may be used as source of data, therefore, potentially covering all known knowledge of bio-molecular entities, therapeutic agents, and diseases. Second, one may apply a molecular network mining method to prioritize disease-specific bio-molecular entities, essentially making use of large amount of molecular interactome information embedded in high-throughput interactome mapping experiments to complement knowledge extracted from biomedical literature. Third, one may use disease-specific bio-molecular entities to extract indirect relationships between diseases and therapeutic agents, therefore providing opportunities for discovery of new therapeutic applications of existing therapeutic agents. Fourth, one may apply advanced statistical techniques (e.g., use of the term frequency statistical method instead of the conventional tf-idf methods to measure term frequency significance, use of false discovery rate for selection of therapeutic agents, and the application of a log-odds function to score bio-molecular entity/therapeutic agent associations), which may collectively increase data processing efficiency and reduce error rates.

In some instances, one may implement a web server to allow users to query and explore molecular connectivity maps developed using methods described herein. Users of the web server may input a query disease name (for example, Alzheimer), and the web server may suggest further standard MeSH disease ontology terms such as “Alzheimer Disease” or “Acute Confusional Senile Dementia” before showing connectivity map data for a specific disease chosen by the user. The connectivity map data may be displayed in an html table, populated with statistically significant bio-molecular entity-therapeutic agent association pairs. Users may navigate through the data's hyperlink to web pages that may contain detailed annotation information on the bio-molecular entity (e.g., “A4_Human”), the therapeutic agent (e.g., “Tacrine”) and/or literature abstract where the bio-molecular entity and therapeutic agent terms may be highlighted in the same abstract context.

Ongoing research to develop molecular connectivity maps of higher coverage and confidence (particularly when applied to other therapeutic disease areas) may present new opportunities for biomedical researchers to perform integrative bioinformatics and chemoinformatics for future therapeutic agent discoveries. Further improvement of molecular connectivity map data accuracy may be achieved by integrating genomics, functional genomics, and proteomics experimental data to build better disease seed bio-molecular entities, incorporating diversified types of molecular interaction network data of growing coverage and quality, and collecting full articles instead of abstracts related to disease's molecular mechanism. Future researchers may explore shifting trends of different such maps that are to be built over different temporal dimensions, among literature sub-collections of journal within different readership and impacts, and under different biological experimental conditions. Results from an example may be integrated with experimental gene expression or protein expression data, as they become available, to improve thorough classification of the type of associative relationships hidden from the bio-molecular entity/therapeutic agent connectivity maps.

Molecular association connectivity maps that connect bio-molecular entity and metabolites also may be developed. For example, bio-molecular entity-metabolite molecular connectivity maps in model organisms may further facilitate comparative genomics analysis. Chemical biologists may further investigate the relationships between common chemical sub-structures and common bio-molecular entity structure motifs for therapeutic agent optimizations. A software server that employs molecular connectivity mapping concepts may also be set up to enable users to gain comprehensive knowledge of bio-molecular entity/therapeutic agent connectivity profiles, compare chemical compounds based on their functional connectivity profile similarities and drill down to specific PubMed® articles for details.

### Constructing Disease-Related Bio-Molecular Entity Interaction Network

In the network construction component, one may construct a disease-related bio-molecular entity interaction network and a ranked list of disease-relevant bio-molecular entity. The disease-related seed bio-molecular entities may be provided by disease biology users or found in any known database, such as OMIM® or OPHID. One may adopt a similar weighted approach when using OPHID data sets, and a similar ranking method when calculating a bio-molecular entity's disease relevance score, rₚ, using the following equation:

rₚ=k*1n(Σ_{qεNET}conf(p,q))−1n(Σ_{qεNET}^{N}(p,q)).

In this equation, p and q may be indices for bio-molecular entities in the disease-related interaction network NET, k may be an empirical constant (I=2 in one example embodiment), and conf(p,q) may be a confidence score assigned to each interaction (p, q) between bio-molecular entity p and q. conf(p,q)=0.9 if (p, q) ε{curated interactions}, conf(p,q)=0.5 if (p, q) .ε{predicted interactions from mammalian organisms}, and conf(p,q)=0.3 if (p, q) ε{predicted interactions from non-mammalian organisms}. N(p,q) holds the value of 1 if the bio-molecular entity p interacts with q. The rₚ score may be used to rank bio-molecular entities and filter out bio-molecular entity-therapeutic agent associations that may arise due to noise in literature mining results.

### Determining and Selecting Enriched Therapeutic Agents

One may use a term frequency statistical method to take advantage of term statistical distributions from the entire PubMed® abstracts, and calculate the p-value of each term's significance in being observed in any collection of retrieved PubMed® abstracts. One reason for doing so may be to control false positives among terms determined to be significantly enriched. For example, observing abnormally high usage frequency of a term from tf-idf could lead to an incorrect inclusion of the term as “enriched,” because the sampled document subset may be biased, and the term usage frequency may be intrinsically variable.

In one example, one may retrieve all PubMed® abstracts using the expanded list {p₁, p₂, . . . , pₘ} containing all the bio-molecular entities in a network as the initial query. From the retrieved abstract collection T_{NET}, the therapeutic agents {d₁, d₂, . . . , dₙ} may be identified automatically by combining both dictionary and rule directives. The present disclosure assumes that the null hypothesis Ho be that document frequency of drug dⱼ in T T_{NET} comes from a random distribution. The t-test value A for therapeutic agent dⱼ may be calculated as:

$${Δ}_{j} = \frac{\overline{( df ( {d}_{j} \vert {T}_{NET}^{′} )} - \overline{df ( {d}_{j} \vert {T}_{Random} ) )}}{\sqrt{\frac{Var ( {d}_{j} \vert {T}_{NET}^{′} )}{{N}_{NET}} + \frac{Var ( {d}_{j} \vert {T}_{Random} )}{{N}_{Random}}}} .$$

Here, T′_{NET}={T′_{NET1}, T′_{NET2}, T′_{NET3}, . . . } can be generated by sampling the entire collection of retrieved document abstracts T_{NET} (where T_{NET1} [symbol] T_{NET},|T′_{NET1}|=C) is a predefined number of documents and N_{NET1}=|T′_{NET}| is the size of each sample. T_{Random}={T_{Random1},T_{Random2},T_{Random3}, . . . } refers to a random sample generated, by randomly sampling the all PubMed® abstracts and the size of the random sample is N_{Random}=|T_{Random}|=C (where C is 1000 to keep it consistent with non-random sample sizes). (̅d̅f̅(̅d̅ⱼ̅|̅T̅′̅_̅{̅N̅E̅T̅}̅)̅ and df (dⱼ|T_{Random}) refer to average document frequencies of dⱼ in T′_{NET} and T_{Random}. (df(dⱼ|T′_{NET}) and df(dⱼ|T_{Random}) refer to document frequency variances of dⱼ in T′_{NET} and T_{Random}. The p-value may be computed as from two-sided tails P(|Z|>|Δ|), where Z˜N(0,1)), as follows:

p=P(|Z|>|Δ|)=2P(Z<−|Δ|).

One may use a standard multiple testing correction method used in microarray analysis to convert p-values from the t-test to calculate a therapeutic agent's false discovery rate (“FDR”). In the end, enriched therapeutic agents {d₁, d₂, . . . d_{g}} may be the ones that met an empirically determined threshold (term frequency>4 and FDR<0.05).

### Connecting Bio-Molecular Entity and Therapeutic Agent for Specific Disease

One may assign a connectivity score e for each possible pair of ranked bio-molecular entities {p₁, p₂, . . . , pₖ} from user inputs and enriched therapeutic agents {d₁, d₂, . . . ,d_{g}}, using a regularized log-odds function. The log-odds framework may be able to qualify association strengths, in particular, facilitated the handling of words, in one example, the connectivity score may be Θ_{pd}=In(df_{pd}*N+λ−In(dfₚ*df_{d}+λ). Here, dfₚ and df_{d} may be the total number of documents in which bio-molecular entity p and therapeutic agent d are mentioned, respectively. df_{pd} may be the total number of documents in which p and d are co-mentioned in the same document. N may be the size of the entire PubMed® abstract collection. k may be a small constant (k=1 here) introduced to avoid out-of-bound errors if any of dfₚ, df_{d}, or df_{pd} values are 0. The resulting Θ_{pd} may be positive when the bio-molecular entity-therapeutic agent pair is over-represented and negative when the pair is under-represented. The higher the Θ_{pd} is, the more significant the over-representation of connection may be. In one embodiment, k×g connectivity scores may be calculated to build a molecular association connectivity map.

### Evaluating AD-Related Therapeutic Agent

A “gold standard” of 843 AD-related therapeutic agents may be constructed using one of the following criteria: (1) Co-citation in the PubMed® abstracts: a therapeutic agent term and all its term variants co-occur with the phrase “Alzheimer's Disease” in at least two PubMed® abstracts. (In other words, it may be assumed that a drug should be related to a disease if it is co-cited with the disease term in more than one article (one may tighten or loosen this criterion in other disease applications)); and (2) Co-occurrence in GeneRIF sentences: a therapeutic agent term and all its term variants co-occur with “Alzheimer's Disease” in at least one gene function annotation GeneRIF entry in the Entrez Gene Database). The present disclosure assumes GeneRIF to contain higher quality information than general PubMed® abstracts when GeneRIF is used to describe the function of a specific gene.

The “gold standard” should not be mistaken for “true confirmed therapeutic agents with therapeutic or toxicological values.” Instead, the gold standard may provide an executable, balanced, and unbiased disease-related therapeutic agent list for performance evaluation purposes only. In the above automated method for AD “gold standard” construction, one may use coverage and disease-relevance as the most important criteria, considering both peer-reviewed article abstracts and curated gene function annotations from reputable databases.

The following measurements are involved in the evaluation and comparison experiments in an example embodiment: (1) Sensitivity is the percent of correctly identified AD-related therapeutic agents; (2) Specificity is the percent of correctly identified non AD-related therapeutic agents; (3) PPV (Positive Predictive Value) is the probability of correct positive prediction; (4) F-score is the harmonic mean of Sensitivity and PPV; (5) Accuracy is the proportion of correctly predicted therapeutic agents. These measurements may be defined as follows:

$$Sensitivity = \frac{TP}{TP + FN}$$

$$Specificity = \frac{TN}{TN + FP}$$

$$PPV = \frac{TP}{TP + FP}$$

$$FScore = \frac{2 * ( PPV * Sensitivity )}{PPV + Sensitivity}$$

$$Accuracy = \frac{TP + TN}{TP + TN + FP + FN} \\$$

Clustering Bio-Molecular Entities in a Disease-Specific Molecular Association Connectivity Map

In the integrated analysis component, 2-D hierarchical clustering of the bio-molecular entity-therapeutic agent connectivity map may be performed using a weighted pair-group method and arithmetic mean method, with Tanimoto as similarity measures. The similarity between two therapeutic agents, dₐ and d_{b}, may be calculated as follows:

$$sim ( {d}_{a} , {d}_{b} ) = \frac{{\sum }_{j = 1}^{k} ( {Θ}_{{p}_{j} {d}_{a}} * {Θ}_{{p}_{j} {d}_{b}} )}{{\sum }_{j = 1}^{k} {Θ}_{{p}_{j} {d}_{a}}^{2} + {\sum }_{j = 1}^{k} {Θ}_{{p}_{j} {d}_{b}}^{2} - {\sum }_{j = 1}^{k} ( {Θ}_{{p}_{j} {d}_{a}} * {Θ}_{{p}_{j} {d}_{b}} )} ,$$

where Θₚ_{ᵢ}_{d}_{ₐ} and Θₚ_{ᵢ}_{d}_{_{b}} are cell values calculated by

Θ_{pd}=In(dfₚ*N+λ)−In(dfₚ*df_{d}+λ).

The similarity between bio-molecular entities, pₐ and p_{b} also may be calculated by

$$sim ( {p}_{a} , {p}_{b} ) = \frac{{\sum }_{j = 1}^{g} ( {Θ}_{{p}_{a} {d}_{j}} * {Θ}_{{p}_{b} {d}_{j}} )}{{\sum }_{j = 1}^{g} {Θ}_{{p}_{a} {d}_{j}}^{2} + {\sum }_{j = 1}^{g} {Θ}_{{p}_{b} {d}_{j}}^{2} - {\sum }_{j = 1}^{g} ( {Θ}_{{p}_{a} {d}_{j}} * {Θ}_{{p}_{b} {d}_{j}} )} .$$

In an example embodiment, final clustered attributes along the therapeutic agent dimension (horizontal axis) and bio-molecular entity dimension (vertical axis) may be sorted by averaged values, decreasing from left to right and from top to bottom. The clustering may be performed and visualized with the Spotfire DecisionSite Browser 8.2 software (TIBCO; Somerville, Mass.), which has been widely used in bioinformatics.

### Devices and Apparatuses

To provide additional context for various aspects of the present invention, the following discussion is intended to provide a brief, general description of a suitable computing environment in which the various aspects of the invention may be implemented.

While one embodiment of the invention relates to the general context of computer-executable instructions that may run on one or more computers, one of skill in the art will recognize that the invention also may be implemented in combination with other program modules and/or as a combination of hardware and software.

Generally, program modules include routines, programs, components, data structures, etc., that perform particular tasks or implement particular abstract data types. Moreover, one of skill in the art will appreciate that aspects of the inventive methods may be practiced with other computer system configurations, including single-processor or multiprocessor computer systems, minicomputers, mainframe computers, as well as personal computers, hand-held wireless computing devices, microprocessor-based or programmable consumer electronics, and the like, each of which can be operatively coupled to one or more associated devices. Aspects of the invention may also be practiced in distributed computing environments where certain tasks are performed by remote processing devices that are linked through a communications network. In a distributed computing environment, program modules may be located in both local and remote memory storage devices.

A computer may include a variety of computer readable media. Computer readable media may be any available media that can be accessed by the computer and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD ROM, digital video disk (“DVD”) or other optical disk storage, magnetic cassettes, magnetic tape, magnetic disk storage or other magnetic storage devices, or any other medium which may be used to store the desired information and which may be accessed by the computer.

An exemplary environment for implementing various aspects of the invention may include a computer that includes a processing unit, a system memory and a system bus. The system bus couples system components including, but not limited to, the system memory to the processing unit. The processing unit may be any of various commercially available processors. Dual microprocessors and other multi processor architectures may also be employed as the processing unit.

The system bus may be any of several types of bus structure that may further interconnect to a memory bus (with or without a memory controller), a peripheral bus, and a local bus using any of a variety of commercially available bus architectures. The system memory may include read only memory (“ROM”) and/or random access memory (“RAM”). A basic input/output system (“BIOS”) is stored in a non-volatile memory such as ROM, EPROM, EEPROM, which BIOS contains the basic routines that help to transfer information between elements within the computer, such as during start-up. The RAM may also include a high-speed RAM such as static RAM for caching data.

The computer may further include an internal hard disk drive (“HDD”) (e.g., EIDE, SATA), which internal hard disk drive may also be configured for external use in a suitable chassis, a magnetic floppy disk drive (“FDD”), (e.g., to read from or write to a removable diskette) and an optical disk drive, (e.g., reading a CD-ROM disk or, to read from or write to other high capacity optical media such as the DVD). The hard disk drive, magnetic disk drive and optical disk drive may be connected to the system bus by a hard disk drive interface, a magnetic disk drive interface and an optical drive interface, respectively. The interface for external drive implementations includes at least one or both of Universal Serial Bus (“USB”) and IEEE 1394 interface technologies.

The drives and their associated computer-readable media provide nonvolatile storage of data, data structures, computer-executable instructions, and so forth. For the computer, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the invention.

A number of program modules may be stored in the drives and RAM, including an operating system, one or more application programs, other program modules and program data. All or portions of the operating system, applications, modules, and/or data may also be cached in the RAM. It is appreciated that the invention may be implemented with various commercially available operating systems or combinations of operating systems.

It is within the scope of the disclosure that a user may enter commands and information into the computer through one or more wired/wireless input devices, for example, a touch screen display, a keyboard and a pointing device, such as a mouse. Other input devices may include a microphone (functioning in association with appropriate language processing/recognition software as known to those of ordinary skill in the technology), an IR remote control, a joystick, a game pad, a stylus pen, or the like. These and other input devices are often connected to the processing unit through an input device interface that is coupled to the system bus, but may be connected by other interfaces, such as a parallel port, an IEEE 1394 serial port, a game port, a USB port, an IR interface, etc.

A display monitor or other type of display device may also be connected to the system bus via an interface, such as a video adapter. In addition to the monitor, a computer may include other peripheral output devices, such as speakers, printers, etc.

The computer may operate in a networked environment using logical connections via wired and/or wireless communications to one or more remote computers. The remote computer(s) may be a workstation, a server computer, a router, a personal computer, a portable computer, a personal digital assistant, a cellular device, a microprocessor-based entertainment appliance, a peer device or other common network node, and may include many or all of the elements described relative to the computer. The logical connections depicted include wired/wireless connectivity to a local area network (“LAN”) and/or larger networks, for example, a wide area network (“WAN”). Such LAN and WAN networking environments are commonplace in offices, and companies, and facilitate enterprise-wide computer networks, such as intranets, all of which may connect to a global communications network such as the Internet.

The computer may be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi (such as IEEE 802.11x (a, b, g, n, etc.)) and Bluetooth™ wireless technologies. Thus, the communication may be a predefined structure as with a conventional network or simply an ad hoc communication between at least two devices.

The system may also include one or more server(s). The server(s) may also be hardware and/or software (e.g., threads, processes, computing devices). The servers may house threads to perform transformations by employing aspects of the invention, for example. One possible communication between a client and a server may be in the form of a data packet adapted to be transmitted between two or more computer processes. The data packet may include a cookie and/or associated contextual information, for example. The system may include a communication framework (e.g., a global communication network such as the Internet) that may be employed to facilitate communications between the client(s) and the server(s).

All of the patents, patent applications, patent application publications and other publications recited herein are hereby incorporated by reference as if set forth in their entirety.

The present invention has been described in connection with what are presently considered to be the most practical and preferred embodiments. However, the invention has been presented by way of illustration and is not intended to be limited to the disclosed embodiments. Accordingly, one of skill in the art will realize that the invention is intended to encompass all modifications and alternative arrangements within the spirit and scope of the invention as set forth in the appended claims.

1. A method, comprising the steps of:
receiving a disease-related bio-molecular entity list from at least one human bio-molecular entity interaction database, wherein the disease-related bio-molecular entity list includes data relating to a plurality of disease-related bio-molecular entities;
receiving a therapeutic agent list from at least one of a medical research literature database;
generating a connectivity score for each possible disease-related bio-molecular entity-therapeutic agent combination; and
constructing a disease-related bio-molecular entity-therapeutic agent molecular association connectivity map in the form of a database accessible by a computer-based query interface, the connectivity map based, at least in part, on the connectivity scores, wherein the generation of the connectivity scores involves the use of at least one of a term frequency statistical method to measure term frequency significance, use of false discovery rate for selection of therapeutic agents, and the application of a log-odds function to score bio-molecular entity/therapeutic agent associations.

2. The method of claim 1, further comprising the step of filtering the disease-related bio-molecular entity-therapeutic agent molecular association connectivity map to output only disease-related bio-molecular entity-therapeutic agent combinations associated with at least one specific disease.

3. The method of claim 1, wherein the connectivity score is indicative of the extent of medical research literature involving one of the plurality of disease-related bio-molecular entities and one of the plurality of therapeutic agents.

4. The method of claim 1, wherein receiving a disease-related bio-molecular entity list from at least one human bio-molecular entity interaction database includes receiving the disease-related bio-molecular entity list from curated sources.

5. The method of claim 1, wherein receiving the disease-related bio-molecular entity list from the at least one human bio-molecular entity interaction database includes receiving the disease-related bio-molecular entity list from a source associated with a specific disease.

6. The method of claim 1, further comprising the steps of:
generating a list of disease-related bio-molecular entities; and
transmitting the list of disease-related bio-molecular entities to a requesting party.

7. The method of claim 1, wherein the disease-related bio-molecular entity is selected from the group consisting of a nucleic acid molecule, amino acid molecule, lipid molecule, saccharide molecule, metabolite, and combination thereof.

8. The method of claim 1, wherein the therapeutic agent is selected from the group consisting of a small molecule, nucleic acid-based molecule, and amino acid-based molecule.

9. The method of claim 1, wherein the disease-related bio-molecular entity-therapeutic agent molecular association is selected from the group consisting of a disease-related nucleic acid molecule-therapeutic agent molecular association, disease-related amino acid molecule-therapeutic agent molecular association, and disease-related nucleic acid molecule/amino acid molecule-therapeutic agent molecular association.

10. A method, comprising the steps of:
generating a disease-related bio-molecular entity list, wherein the disease-related bio-molecular entity list includes data obtained from at least one human bio-molecular entity interaction database, and wherein the disease-related bio-molecular entity list includes data relating to a plurality of disease-related bio-molecular entities;
generating a therapeutic agent list, wherein the therapeutic agent list includes data obtained from the at least one medical research literature database;
generating a connectivity score for each possible disease-related bio-molecular entity-therapeutic agent combination; and
constructing a disease-related bio-molecular entity-therapeutic agent molecular association connectivity map in the form of a database accessible by a computer-based query interface, the connectivity map based, at least in part, on the connectivity scores, wherein the generation of the connectivity scores involves the use of at least one of a term frequency statistical method to measure term frequency significance, use of false discovery rate for selection of therapeutic agents, and the application of a log-odds function to score bio-molecular entity/therapeutic agent associations.

11. The method of claim 10, wherein the disease-related bio-molecular entity is selected from the group consisting of a nucleic acid molecule, amino acid molecule, lipid molecule, saccharide molecule, metabolite, and combination thereof.

12. The method of claim 10, wherein the therapeutic agent is selected from the group consisting of a small molecule, nucleic acid-based molecule, and amino acid-based molecule.

13. The method of claim 10, wherein the disease-related bio-molecular entity therapeutic agent molecular association is selected from the group consisting of a disease-related nucleic acid molecule-therapeutic agent molecular association, disease related amino acid molecule-therapeutic agent molecular association, and disease related nucleic acid molecule/amino acid molecule-therapeutic agent molecular association.

14. A method, comprising the steps of:
receiving a disease-related bio-molecular entity list from at least one human bio-molecular entity interaction database, wherein the disease-related bio-molecular entity list includes data relating to a plurality of disease-related bio-molecular entities;
receiving a therapeutic agent list from at least one of a medical research literature database;
generating a connectivity score for each possible disease-related bio-molecular entity-therapeutic agent combination; and
constructing a disease-related bio-molecular entity-therapeutic agent molecular association connectivity map in the form of a database accessible by a computer-based query interface, the connectivity map database including a plurality of triples comprising disease, therapeutic agent, and bio-molecular entity information with an associated connectivity score, said database of said triples including clusters of said triples having attributes across at least one of the therapeutic entity dimension and the bio-molecular entity dimension.

15. The method of claim 14, wherein the connectivity map database is configured to output, cluster, and filter the bio-molecular entity-therapeutic agent molecular association connectivity map associated with at least one specific disease.

16. The method of claim 15, wherein the disease-related bio-molecular entity data is obtained from at least one bio-molecular entity database for the at least one specific disease.

17. The method of claim 14, wherein the bio-molecular entity-therapeutic agent molecular association connectivity map comprises a two-dimensional matrix relating the associations or non-associations between the plurality of disease-related bio-molecular entities and the plurality of therapeutic agents.

18. The method of claim 17, wherein each of the associations and non-associations between the plurality of disease-related bio-molecular entities and the plurality of therapeutic agents is represented by a connectivity score, and including a two dimensional matrix comprised of a plurality of colored and shaded cells associated with the connectivity scores.

19. The method of claim 18, wherein the connectivity scores includes a statistical confidence score indicating an extent of literature studies involving one of the plurality of disease-related bio-molecular entities and one of the plurality of therapeutic agents.

20. The method of claim 14, wherein the disease-related bio-molecular entity data and therapeutic agent data is obtained by data mining medical research documents.
